(19) United States
(12) Patent Application Publication
(10) Pub. No.: US 2026/0238402 A1
(43) Pub. Date: Aug. 13, 2026

(54) LINK PERFORMANCE MONITORING VIA IN-BAND MANAGEMENT CHANNEL

(71) Applicant: Credo Technology Group Limited, George Town (KY)

(72) Inventors: JUNQING SUN, FREMONT, CA (US); HAOLI QIAN, FREMONT, CA (US)

(73) Assignee: Credo Technology Group Limited, George Town (KY)

(21) Appl. No.: 19/050,664

(22) Filed: Feb. 11, 2025

(51) Int. Cl. H04L 1/20; H04L 1/00; H04L 1/24

(52) U.S. Cl. CPC H04L 1/203; H04L 1/0057; H04L 1/24

(57) ABSTRACT

Link performance monitoring methods and circuits are provided for incorporation into active cables or transceivers for communication links providing in-band management channels. One illustrative method includes: receiving a first digital symbol stream from a remote node, the first digital symbol stream including an error-correction coded data stream with added test blocks; conveying the first error-correction coded data stream to a local host; deriving a link performance indicator from the added test blocks; and conveying the link performance indicator to the remote node. An illustrative transceiver includes: a receive chain that derives a received digital symbol stream from a receive signal, the received digital symbol stream including an error-correction coded data stream from a remote node with added test blocks; an error analysis module configured to derive a link performance indicator from the added test blocks; and a transmit chain configured to convey the link performance indicator to the remote node.

### TECHNICAL FIELD

The present disclosure relates generally to serializer/deserializer transceivers and more specifically to transceivers that provide an in-band communication channel for exchanging management information.

### BACKGROUND

Data centers for Al services, cloud computing, media streaming, social media platforms, etc., tend to be large, complex installations having hundreds of thousands servers interconnected by routers and a correspondingly large number of network cables, each cable being asked to support data transfer rates near the limits of what is currently achievable. To enhance their performance, so-called “active” cables typically rely on embedded electronics that perform signal processing on the received signals (and often on the signals to be transmitted as well). Such cables may comply with various network communications standards such as, e.g., the Institute of Electrical and Electronics Engineers (IEEE) Standard for Ethernet, IEEE Std 802.3-2015, which provides a common media access control specification for local area network (LAN) operations at various data rates with various signal constellations over coaxial cable, twin axial cable, twisted wire pair cable, fiber optic cable, and electrical backplanes. As demand continues for ever-higher data rates, the standard is being extended. Such extensions to the standard must account for increased channel attenuation and dispersion even as the equalizers are forced to operate at faster symbol rates.

For distance spans of no more than 2 meters, attenuation is reasonably limited such that passive copper cable, also known as direct-attach cable or “DAC”, can often be employed. Data centers having larger distance spans may need to rely on active cable designs having embedded electronics for data recovery and remodulation (DRR). While the electronics embedded in each cable connector can employ a dedicated channel, such as a twisted wire pair between the end connectors, to exchange management information (e.g., configuration information, status information, firmware updates, and the like.), it may be preferred to employ an in-band management channel such as that disclosed in co-owned U.S. application Ser. No. 18/533,703, titled “SerDes Method and Device having a Protocol-Agnostic In-Band Management Channel”.

As with most integrated circuit devices, the DRR chips have become so complex that it is impractical for electronic device designers to design them from scratch. Instead, electronic device designers rely on predefined modular units of integrated circuit layout designs, arranging and joining them as needed to implement the various desired functions. Each modular unit has a defined interface and behavior that has been verified by its creator. Though each modular unit may take substantial time and investment to create, its availability for re-use and further development cuts product cycle times dramatically and enables better products. The predefined units can be organized hierarchically, with a given unit incorporating one or more lower-level units and in turn being incorporated within higher-level units. Many organizations have libraries of such predefined modular units for sale or license, including, e.g., embedded processors, memory, interfaces for different bus standards, power converters, frequency multipliers, sensor transducer interfaces, to name just a few. The predefined modular units are also known as cells, blocks, cores, and macros, terms which have different connotations and variations (“IP core”, “soft macro”) but are frequently employed interchangeably.

The modular units can be expressed in different ways, e.g., in the form of a hardware description language (HDL) file, or as a fully routed design that could be printed directly to a series of manufacturing process masks. Fully routed design files are typically process-specific, meaning that additional design effort would usually be needed to migrate the modular unit to a different process or manufacturer. Modular units in HDL form require subsequent synthesis, placement, and routing steps for implementation, but are process-independent, meaning that different manufacturers can apply their preferred automated synthesis, placement, and routing processes to implement the units using a wide range of manufacturing processes. By virtue of their higher-level representation, HDL units may be more amenable to modification and the use of variable design parameters, whereas fully routed units may offer better predictability in terms of areal requirements, reliability, and performance. While there is no fixed rule, digital module designs are more commonly specified in HDL form, while analog and mixed-signal units are more commonly specified as a lower-level, physical description.

One consequence of the sheer volume of electronics in a data center is that relatively uncommon hardware failures become an everyday occurrence. Real time link performance monitoring would enable data center technicians to avoid or mitigate the effects of network cable failure by identifying degraded or faulty cables for replacement.

### SUMMARY

Accordingly, there are disclosed herein link performance monitoring methods and circuits suitable for incorporation into active cables or transceivers for communication links providing in-band management channels. One illustrative method includes: receiving a first digital symbol stream from a remote node, the first digital symbol stream including an error-correction coded data stream with added test blocks; conveying the first error-correction coded data stream to a local host; deriving a link performance indicator from the added test blocks; and conveying the link performance indicator to the remote node.

An illustrative transceiver includes: a receive chain that derives a received digital symbol stream from a receive signal, the received digital symbol stream including an error-correction coded data stream from a remote node with added test blocks; an error analysis module configured to derive a link performance indicator from the added test blocks; and a transmit chain configured to convey the link performance indicator to the remote node.

An illustrative network cable includes: a first connector having a first transceiver configured to provide a first digital symbol stream having a first error-correction coded data stream from a first network port with added test blocks; and a second connector. The second connector includes: a second transceiver configured to receive the first digital symbol stream and to convey the first error-correction coded data stream to a second network port; and an error analysis module configured to derive a first link performance indicator from the added test blocks, the second transceiver being further configured to convey the first link performance indicator to the first connector.

An illustrative data center includes a computer network having a network cable connected between a first network port of a first network node and a second network port of a second network node. The cable includes: a first transceiver configured to provide a first digital symbol stream having a first error-correction coded data stream from the first network port with added test blocks; a second transceiver configured to receive the first digital symbol stream and to convey the first error-correction coded data stream to the second network port; and an error analysis module configured to derive a first link performance indicator from the added test blocks, the second transceiver being further configured to convey the first link performance indicator to the first transceiver The embedded electronics for the foregoing examples can be embodied as a semiconductor IP core stored on a non-transitory information storage medium. When used by a suitably configured computer, the semiconductor IP core provides the circuit and/or process mask designs for manufacturing integrated circuit devices having the components to implement the above-described examples.

Each of the foregoing implementations may be embodied individually or conjointly and may be combined with any one or more of the following optional features: 1. the conveying includes transmitting a second digital symbol stream to the remote node, the second digital symbol stream including an error-correction coded data stream from the local host and including added control blocks providing the link performance indicator. 2. the first digital symbol stream further includes added control blocks providing a link performance indicator for the second digital symbol stream. 3. adjusting a communication parameter if the link performance indicator for the second digital symbol stream exceeds a target threshold. 4. the link performance indicator is an estimated code word error rate that accounts for error correction coding of the error-correction coded data stream. 5. the added test blocks comprise a frame header and a pseudo-random binary sequence (PRBS). 6. the error analysis module includes: a bit counter configured to divide the PRBS into symbols and code words; an error counter configured to determine a symbol error count for each code word; and an aggregator configured to accumulate the symbol error counts to obtain a distribution.

### BRIEF DESCRIPTION OF THE DRAWINGS

FIG. 1 is a perspective view of an illustrative active network cable.

FIG. 2 is a block diagram of the illustrative network cable.

FIG. 3 is a block diagram of an illustrative receive chain.

FIG. 4 is a block diagram of an illustrative data recovery and remodulation (DRR) transmit path.

FIG. 5 is a block diagram of an illustrative DRR receive path.

FIG. 6 is a block diagram of an illustrative error analysis module.

FIG. 7 is a graph of an illustrative histogram.

FIG. 8 shows an illustrative added test block.

### DETAILED DESCRIPTION

While specific embodiments are given in the drawings and the following description, keep in mind that they do not limit the disclosure. On the contrary, they provide the foundation for one of ordinary skill to discern the alternative forms, equivalents, and modifications that are encompassed in the scope of the appended claims.

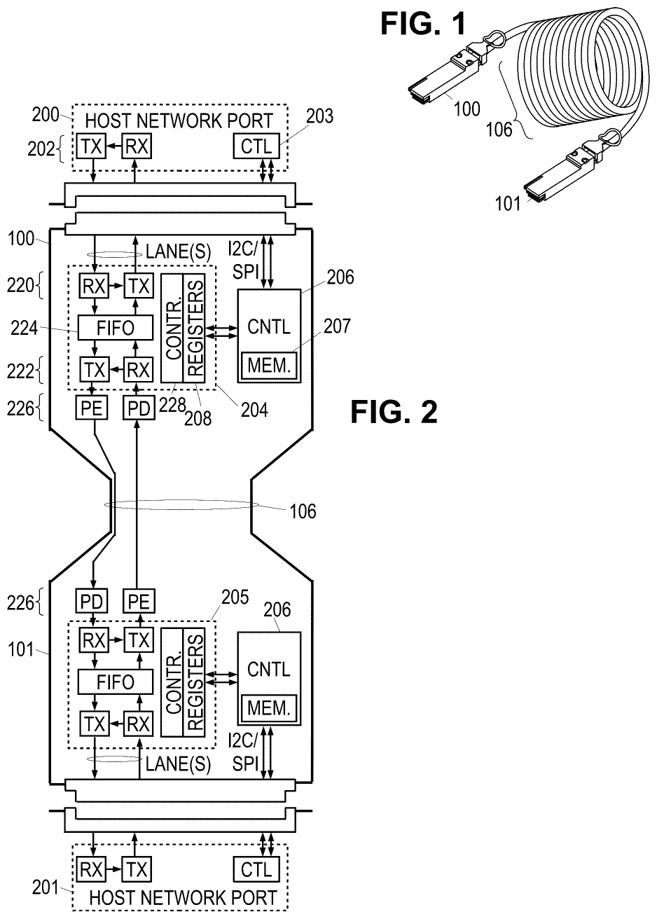

FIG. 1 is a perspective view of an illustrative cable that may be used to provide a high-bandwidth communications link between devices in a computer network. The computer network may be or include, for example, the Internet, a wide area network, a storage area network, or a local area network. The linked devices may be computers, switches, routers, and the like. The cable includes a first end connector 100 and a second end connector 101 that are electrically connected via electrical conductors or are optically coupled via optical fibers in a cord 106. Illustrative electrical conductors include electrically conductive wires arranged in a paired form such as with twin axial conductors. Twin axial conductors can be likened to coaxial conductors, but with two inner conductors instead of one. The inner conductors may be driven with a differential signal, and their shared shield operates to reduce crosstalk with other twin axial conductors in the cable. Pursuant to the Ethernet standard, each conductor pair may provide unidirectional transport of a differential signal. Depending on the performance criteria, it may be possible to employ other paired or single-ended conductor implementations. For optical cables, the optical fibers may provide unidirectional transport of optical signals.

To enable robust performance over even extended cable lengths, each end connector 100, 101 may include a powered transceiver that performs data recovery and re-modulation (DRR) of data streams. The DRR transceivers process data streams traveling in each direction. Notably, the transceivers perform re-modulation not only of the inbound data streams to the host interface as they exit the cable, but also of the outbound data streams from the host interface as they enter the cable. In addition to ensuring modulation quality suitable for an extended cable length, the processing at both ends enables the implementation of an in-band management channel and link performance monitoring as described below.

FIG. 2 is a block diagram of the illustrative cable of FIG. 1. End connector 100 inserts into a network port of a first host 200, while end connector 101 inserts into a network port of a second host 201. Both the local and remote network ports include a transceiver 202 and a port controller 203 that coordinates operation of the network port components. Each of the end connectors 100, 101 includes a plug adapted to fit a respective network port 200, 201 to receive an electrical input signal carrying an outbound data stream from the host device and to provide an electrical output signal carrying an inbound data stream to the host device. The network ports 200, 201, provide a network interface with one or more transceivers 202 to generate outbound data stream signals and to receive inbound data stream signal. The one or more transceivers 202 are associated with a port controller 203 having pins for a control bus supporting the I2C bus protocol, SPI bus protocol, MDIO bus protocol, or the like, to configure operation of the one or more transceivers 202 and to access configuration registers of the cable, enabling the host device to adjust the cable's operating parameters and monitor the cable's performance.

End connector 100 includes a first DRR device 204 to perform symbol recovery and re-modulation of the data streams entering and exiting the cable at end connector 100, and end connector 101 includes a second DRR device 205 to perform symbol recovery and re-modulation of the data streams entering and exiting the cable at end connector 101. The DRR devices 204, 205 may each be an integrated circuit device mounted on a printed circuit board and connected to connector plug pins via circuit board traces.

In at least some contemplated embodiments, the printed circuit boards each also support a controller chip (CNTL) 206. Each DRR device 204, 205 is coupled to a respective controller 206 which configures the operation of the DRR device via a first two-wire bus. At power-on, the controller 206 loads equalization parameters from Flash memory 207 into the DRR device's configuration registers 208. As described further below, the controllers 206 can use an in-band management channel to monitor, among other things, error rates that account for error correction coding of the data streams. If the error rates are approaching the correctability threshold of the forward error correction code, the controller 206 can notify the port controller of the issue within seconds to ensure maintenance or other corrective actions can be performed in a timely fashion. The host device can also initiate access the controller 206 via a second two-wire bus to adjust the cable's operating parameters and monitor the cable's performance.

Each DRR device 204, 205, includes a set 220 of host-side transmitters and receivers (“transceivers”) for communicating with the host device and a set 222 of line-side transceivers for sending and receiving via conductor pairs or optical fibers running the length of the cord 106. The DRR devices for the illustrated cable each couple to a set 226 of photoemitters (PE) and photodetectors (PD) for converting between electrical signals for the DRR devices and optical signals for transport over the optical fibers. Only one communication lane is shown for ease of illustration, but in practice the cable may employ multiple communication lanes over corresponding differential conductor pairs or optical fibers or multiple multiplexed channels on a single conductor pair or optical fiber to support higher communication bandwidths. The DRR devices may include a memory 224 to provide first-in first-out (FIFO) buffering between the transceiver sets 220, 222. An embedded controller 228 coordinates the operation of the transmitters and receivers by, e.g., setting initial equalization parameters and ensuring the training phase is complete across all lanes and links before enabling the transmitters and receivers to enter the data transfer phase. The embedded controller 228 employs a set of registers 208 to receive commands and parameter values, and to provide responses potentially including status information and performance data.

As previously mentioned, there exists a need to exchange messages between the two end connectors 100, 101. An in-band messaging technique offers a way to avoid the added bulk and cost that would be associated with a dedicated channel for management information. In this technique, the line-side signaling employs a slightly higher symbol rate than the host-side signaling. The baud rate increase is expected to be no more than about 10 parts-per-million (ppm), i.e., within the channel tolerance.

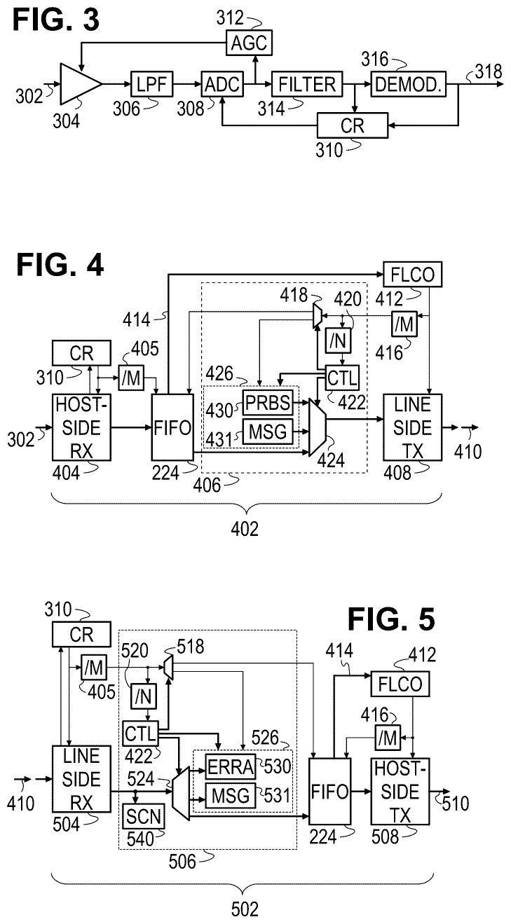

Each of the transceivers in FIG. 2 includes a receiver, i.e., a receive chain, to convert an analog receive signal 302 into a digital symbol stream 318. FIG. 3 shows an illustrative receive chain that includes a programmable gain amplifier 304 to provide gain control. A continuous time low pass filter 306 blocks frequencies above the Nyquist frequency to prevent aliasing by the analog to digital converter (ADC) 308. ADC 308 samples the filtered receive signal in accordance with a sample clock from clock recovery module 310. An adaptive gain control (AGC) module 312 monitors the digital sample stream from ADC and adjusts the gain setting of amplifier 304 to optimize operation of the ADC. A finite impulse response (FIR) digital filter 314 operates on the digital sample stream from ADC 308 to at least partly compensate for channel effects. A demodulator 316 such as, e.g., a decision feedback equalizer, converts the filtered digital receive signal into a digital receive symbol stream 318. The clock recovery module 310 may derive the sample clock signal in various ways described in the open literature, typically by comparing the input and output of a decision element in in demodulator 316.

Each DRR device 204, 205 includes a transmit path 402 from the host side receiver to the line side transmitter, and a receive path 502 from the line side receiver to the host side transmitter. FIG. 4 shows an illustrative transmit path 402 with a receive chain 404 and clock recovery module 310 operating to convert the analog receive signal into a digital symbol stream. It is expected that the received digital symbol stream has been error-correction encoded by the host. Memory 224 acts as a first-in first-out (FIFO) buffer for temporary storage of the digital symbol stream. A frequency divider 405 coverts the sample clock from the clock recovery module 310 to a word clock, enabling writes to the FIFO buffer 224 to occur a word at a time. An illustrative word size (and hence division factor M of divider 405) is 32 or 64 digital symbols, where a symbol may be a bit or a PAM4 symbol.

The illustrated transmit path further includes an in-band channel insertion module 406, which supplies a data stream to line-side transmitter 408 for conveyance along the cable. Module 406 embeds an in-band management channel which, as described below, may include added test blocks for evaluating link performance. Transmit signal 410 according represents an error correction coded data stream with added test blocks. Transmitter 408 receives a symbol clock from an oscillator 412, herein referred to as a fill-level controlled oscillator (FLCO). Oscillator 412 filters a fill level signal 414 to control the symbol clock frequency as needed to provide a steady buffer fill level, on average. The fill level will rise when the insertion module 406 adds blocks to the data stream and fall when the transmitter transmits buffer contents at a slightly elevated clock frequency. A frequency divider 416 converts the transmit symbol clock to a transmit word clock in similar fashion to divider 405. Under control of an embedded control logic (CTL) 422, a clock demultiplexer (demux) 418 selectively directs the transmit word clock as a read clock to FIFO buffer 224 or to management channel buffer 426. The control logic 422 also controls a source multiplexer (mux) 424 to provide the words read from the FIFO buffer 224 or the channel buffer 426 to the line side transmitter 408. The control logic 422 may rely on a word counter 420 to determine data stream locations for insertion of management channel blocks and to determine when an added block has been sent and the mux 424 and clock demux 418 should be switched back to the FIFO buffer 224. As discussed further below, an illustrative block size is 5504 symbols, and added blocks may be separated by some multiple of 5504 symbols. The block size and number of intervening blocks may be an adjustable configuration parameter.

The illustrated management channel buffer 426 includes a message buffer 431 and a predetermined sequence source 430, e.g., a pseudorandom binary sequence (PRBS) generator. Such PRBS generators are known in the literature and are efficiently implemented as linear-feedback shift registers configured to produce maximum length sequences, i.e., a sequence of length 2^{m}-1 for an m-bit shift register. Source 430 generates the added test blocks, while message buffer 431 buffers the content of control blocks. As indicated in FIG. 8, each of the added blocks may include a 64-symbol frame header to indicate whether the added block is a test block or a control block. The control blocks may be used to convey configuration information, to capture the current state of the DDR device's control registers, or to exchange messages for coordinated operations.

The transmit signal 410 (with added noise and channel interference) becomes a receive signal at the input to the receive path 502 of FIG. 5. A line-side receive chain 504 converts the analog receive signal into a digital symbol stream representing an encoded data stream with added blocks. An in-band extraction module 506 includes a stream demux 524 that operates under control of control logic 422 to direct the added blocks to a management channel terminus 526 and to direct the encoded data stream blocks to a FIFO buffer 224. A host-side transmitter 508 converts the encoded data stream from FIFO buffer 224 into an analog transmit signal 510 for conveying the data stream to the host network port.

Under control of the control logic 422, a clock demux 518 directs the word clock to the FIFO buffer 224 when the digital symbol stream represents the error correction coded data stream, and directs the word clock to the terminus 526 when the digital symbol stream represents an added block. A word counter 520 supports the embedded controller's separation of the in-band management channel from the encoded data stream. The management channel terminus 526 includes an error analysis module 530 and a message buffer 531. The error analysis module 530 operates on the test blocks to determine one or more indicators of link performance. The message buffer 531 may store control blocks for control logic 422 to access and use in accordance with the management channel protocol.

As previously mentioned, the added blocks may contain headers to identify added test blocks and added control blocks. For example, the header for the test blocks may be 0xFFFF0000 00FF00FF, whereas the header for the control blocks may be, e.g., 0xFFFF0000 FF00FF00. The control blocks may be provided with a frame structure that includes control fields and a CRC checksum. The terminus 506 may include scan logic 540 that scans for such headers until the control logic 422 achieves synchronization between the word counter 520 and the in-band management channel blocks.

A transmit path 402 in end connector 100 cooperates with a receive path 502 in end connector 101 to convey an error correction coded data stream in one direction between the network ports. A transmit path 402 in end connector 101 cooperates with a receive path 502 in end connector 100 to convey an error correction coded data stream in the opposite direction between the network ports. The two data streams may be grouped to form one lane of the link. The in-band management channel of one data stream may contain configuration and control information for the data stream conveyed in the opposite direction, enabling a transmit path to monitor link performance and potentially adapt configuration parameters to combat degradation. The DRR devices may include multiple transmit and receive paths to support multiple lanes.

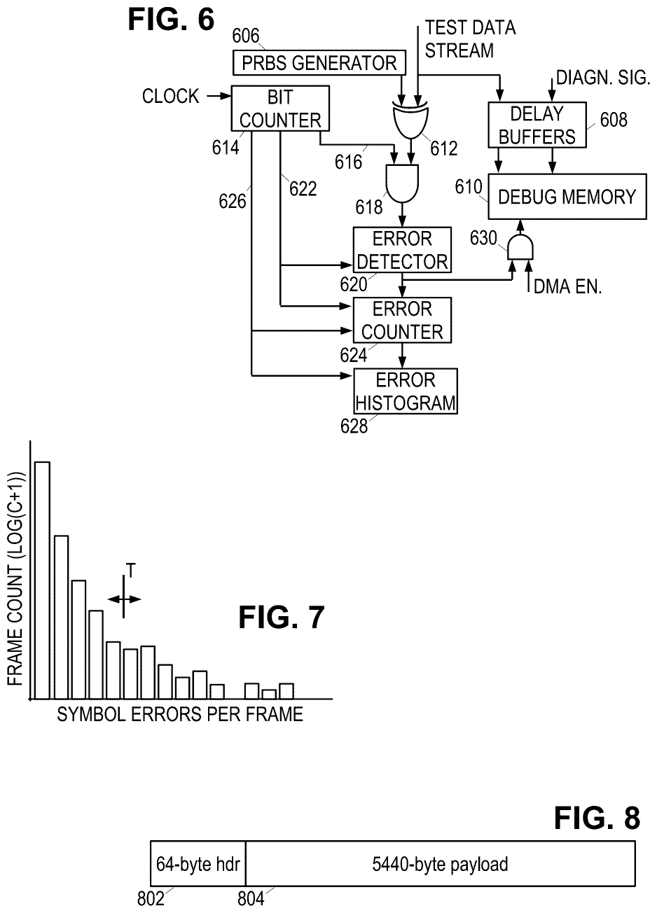

To analyze link performance while accounting for error correction encoding, the error analysis module 530 may have the illustrative implementation shown in FIG. 6. A local copy of the predetermined test block pattern may be held in nonvolatile memory or generated with a local PRBS generator 606. The test data stream and the local copy of the predetermined test pattern, along with any other desired diagnostic signals (e.g., phase errors in the timing recovery module), passes through corresponding delay buffers 608 to provide adequate opportunity for a trigger signal to be generated. If a trigger signal occurs, a debug memory 610 captures the test data stream, the local copy of the predetermined bit stream, and the other diagnostic signals. A logical AND gate generates the trigger signal when an error is detected while the control logic 422 asserts a debug enable signal. The volume of data captured per trigger event may be a configurable parameter. The captured data may be conveyed to the far end of the cable via the in-band management channel and/or to the port controller of the local network port.

Though in the most general sense, the receive chain converts the analog receive signal into a stream of channel symbols, the DRR device internally represents the symbol stream as a stream of bits, e.g., using a bit pair to represent each PAM4 symbol. The forward error correction coding techniques provided in the Ethernet standard and other comparable standards for network communications map the unencoded data stream to code symbols representable as bytes or words. In the following discussion, the term “symbol” refers to code symbols rather than channel symbols.

Error correction coding introduces redundancy into the data stream to enable detection and correction of up to T symbols in a given code word, where T depends on the specific technique. Channel interference often causes error bursts that can exceed this threshold. To protect against such bursts, error correction coding often employs code word reordering in combination with interleaving of symbols from different code words, causing the symbol errors from a given burst to be more widely redistributed among multiple code words during the decoding process. Only a subset of the symbol errors will be associated with a given code word.

A logical XOR gate 612 compares the test data stream to the local copy of the bitstream for the added test block, asserting an error signal whenever there is a mismatch between the bit streams. A bit counter 614 counts bits in the test data stream, generating a gate signal 616 to account for interleaving of bits from different codewords. The gate signal 616 is asserted for each bit in an interleaved symbol and de-asserted for the other bits that may occur within the span of a symbol. The bit counter further generates a symbol boundary signal 622, and a code word boundary signal 626. The interleaving degree (i.e., number of other bits between symbol bits), symbol length (i.e., number of bits per symbol), and code word length (i.e., number of symbols per code word) are each preferably configurable parameters for the error analysis module.

The interleaving referenced above can take various forms, including interleaving of FEC encoded data streams from multiple FEC encoders across multiple communications lanes. The gate signal 616 for each lane may be set to select only the symbols in that lane originating from a selected FEC encoder. When the error statistics gathered for each lane are merged, e.g., via convolution of the histograms for each lane, the performance of the selected FEC encoder can be evaluated despite having its encoded symbols distributed across multiple communications lanes.

A logical AND gate 618 combines the gate signal 616 with the error signal from comparator 612 to form a gated error signal which is asserted when an error is present in a bit of a selected symbol. An error detector 620 receives the gated error signal, deriving from it a symbol error signal, which is asserted whenever an error is detected in any of the bits of a symbol. For serial bit streams, the error detector 620 may be implemented as a S-R flip flop being set when the gated error signal is asserted, and getting reset by the symbol boundary signal 622 before the beginning of a new symbol. For parallelized bit streams, a set of OR gates may be employed to synthesize the symbol error signal from the parallel gated error signals. In some embodiments, the symbol boundaries may be fixed, e.g., with every cycle of the parallel test data stream presumed to represent one symbol.

A symbol error counter 624 counts the number of symbol errors detected in each code word. When the symbol boundary signal 622 is asserted, the symbol error counter 624 increments if the symbol error signal is asserted, or remains the same otherwise. The code word boundary signal 626 resets the counter 624 before the beginning of a new code word. The symbol error count from counter 624 is used to increment a register in an error histogram module 628 when the code word boundary signal 626 is asserted. In some embodiments, the error histogram module 628 includes fifteen registers, each register corresponding to one of 0, 1, 2, 3, . . . , 13, or 14 symbol errors in a code word. A sixteenth register may be incremented whenever the error count exceeds 14 symbol errors in a code word. In this fashion, the histogram module counts the number of code words having the corresponding number of symbol errors. The registers are preferably incremented without rollover. The register contents are periodically provided via the in band management channel to the DRR device in the remote end and/or to the port controller of the local host.

FIG. 7 shows an illustrative symbol error histogram having 16 bins along the horizontal axis, with the first bin corresponding to zero symbol errors and the sixteenth corresponding to 15 or more symbol errors. The vertical axis shows the number of code words counted in each bin on a modified logarithmic scale (logarithm of count plus one). Thus it is possible to determine the pre-FEC symbol error rate with a weighted sum of bins 2 through 16, divided by the count in bin 1.

FIG. 7 also shows a correctability threshold T, which is set by the choice of FEC code. The correctability threshold T is the maximum number of symbol errors that can be corrected in a code word by the error correction code. If more symbol errors occur, the code word cannot be corrected and the symbol errors remain uncorrected, potentially resulting in data loss. Thus it is possible to determine the post-FEC symbol error rate with a weighted sum of bins above T+1, divided by the total number of code words counted in bins 1 through T. Because the in band management channel data is conveyed under the same conditions as the host data streams, the controllers 206 can track the post-FEC error rate in real time and detect changes in less than a second, enabling the cable connectors to quickly alert the hosts when the link performance degrades.

Embedded control logic 422 for the insertion module 406 may also serve as the control logic for the local extraction module 506 to implement a suitable in band messaging protocol. The control logic 422 may be application specific integrated circuitry configured to implement the selected messaging protocol using a finite state machine, and upon receiving an added control block or added test data block, may appropriately process the block as captured in the relevant buffer.

Numerous alternative forms, equivalents, and modifications will become apparent to those skilled in the art once the above disclosure is fully appreciated. For example, a 1:1 cable has been used in the foregoing description, but the principles disclosed hereinbelow are also applicable to optical modules, standalone transceivers, breakout cables, and other applications of SerDes devices. The transceivers may also provide bit multiplexing to convert between a first number of lanes on the host side and a second number of lanes on the line side. Though a fill-level-based determination of line-side clock frequencies is advantageous, it is not a requirement as the line side clock frequency can be determined in other ways with, e.g., bit stuffing being used to compensate for buffer underfills. It is intended that the claims be interpreted to embrace all such alternative forms, equivalents, and modifications that are encompassed in the scope of the appended claims.

What is claimed is:

1. A method that comprises;
receiving a first digital symbol stream from a remote node, the first digital symbol stream including an error-correction coded data stream with added test blocks;
conveying the first error-correction coded data stream to a local host;
deriving a link performance indicator from the added test blocks; and
conveying the link performance indicator to the remote node.

2. The method of claim 1, wherein said conveying includes:
transmitting a second digital symbol stream to the remote node, the second digital symbol stream including an error-correction coded data stream from the local host and including added control blocks providing the link performance indicator.

3. The method of claim 2, wherein the first digital symbol stream further includes added control blocks providing a link performance indicator for the second digital symbol stream, and wherein the method further comprises adjusting a communication parameter if the link performance indicator for the second digital symbol stream exceeds a target threshold.

4. The method of claim 3, wherein the link performance indicator is an estimated code word error rate that accounts for error correction coding of the error-correction coded data stream from the local host.

5. The method of claim 4, wherein the added test blocks comprise a frame header and a pseudo-random binary sequence (PRBS), and wherein said deriving includes:
using a bit counter to divide the PRBS into symbols and code words;
determining a symbol error count for each code word; and
accumulating the symbol error counts to obtain a distribution.

6. A transceiver that comprises:
a receive chain that derives a received digital symbol stream from a receive signal, the received digital symbol stream including an error-correction coded data stream from a remote node with added test blocks;
an error analysis module configured to derive a link performance indicator from the added test blocks; and
a transmit chain configured to convey the link performance indicator to the remote node.

7. The transceiver of claim 6, wherein the transmit chain is further configured to transmit a second digital symbol stream to the remote node, the second digital symbol stream including an error-correction coded data stream from a local host and including added control blocks providing the link performance indicator.

8. The transceiver of claim 7, wherein the first digital symbol stream further includes added control blocks providing a link performance indicator for the second digital symbol stream, and wherein the receive chain is configured to adjust a communication parameter if the link performance indicator for the second digital symbol stream exceeds a target threshold.

9. The transceiver of claim 6, wherein the link performance indicator is an estimated code word error rate that accounts for error correction coding of the error-correction coded data stream from the remote node.

10. The transceiver of claim 6, wherein the added test blocks comprise a frame header and a pseudo-random binary sequence (PRBS), and wherein the error analysis module includes:
a bit counter configured to divide the PRBS into symbols and code words;
an error counter configured to determine a symbol error count for each code word; and
an aggregator configured to accumulate the symbol error counts to obtain a distribution.

11. A cable that comprises:
a first connector having a first transceiver configured to provide a first digital symbol stream having a first error-correction coded data stream from a first network port with added test blocks;
a second connector having:
a second transceiver configured to receive the first digital symbol stream and to convey the first error-correction coded data stream to a second network port; and
an error analysis module configured to derive a first link performance indicator from the added test blocks,
the second transceiver being further configured to convey the first link performance indicator to the first connector.

12. The cable of claim 11, wherein the second transceiver is configured to provide a second digital symbol stream having a second error-correction coded data stream from the second network port with added control blocks that convey the first link performance indicator.

13. The cable of claim 12, wherein the first digital symbol stream further includes added control blocks providing a second link performance indicator for the second digital symbol stream, and wherein the second transceiver is configured to adjust a communication parameter if the second link performance indicator for the second digital symbol stream exceeds a target threshold.

14. The cable of claim 13, wherein the second link performance indicator is an estimated code word error rate that accounts for error correction coding of the second error-correction coded data stream.

15. The cable of claim 11, wherein the added test blocks comprise a frame header and a pseudo-random binary sequence (PRBS), and wherein the error analysis module includes:
a bit counter configured to divide the PRBS into symbols and code words;
an error counter configured to determine a symbol error count for each code word; and
an aggregator configured to accumulate the symbol error counts to obtain a distribution.

16. A computer network that comprises:
a network cable connected between a first network port of a first network node and a second network port of a second network node, the cable including:
a first transceiver configured to provide a first digital symbol stream having a first error-correction coded data stream from the first network port with added test blocks;
a second transceiver configured to receive the first digital symbol stream and to convey the first error-correction coded data stream to the second network port; and
an error analysis module configured to derive a first link performance indicator from the added test blocks,
the second transceiver being further configured to convey the first link performance indicator to the first transceiver

17. The computer network of claim 16, wherein the second transceiver is configured to provide a second digital symbol stream having a second error-correction coded data stream from the second network port with added control blocks that convey the first link performance indicator.

18. The computer network of claim 17, wherein the network cable further includes a controller that tracks the first link performance indicator and conveys an alert to the first network node if the first link performance indicator indicates degraded performance.

19. The computer network of claim 18, wherein the second link performance indicator is an estimated code word error rate that accounts for error correction coding of the second error-correction coded data stream.

20. The computer network of claim 19, wherein the added test blocks comprise a frame header and a pseudo-random binary sequence (PRBS), and wherein the error analysis module includes:
a bit counter configured to divide the PRBS into symbols and code words;
an error counter configured to determine a symbol error count for each code word; and
an aggregator configured to accumulate the symbol error counts to obtain a distribution.
